(19) United States
(12) Patent Application Publication
(10) Pub. No.: US 2020/0203108 A1
(43) Pub. Date: Jun. 25, 2020

(54) LINE SIDE POWER, DOUBLE BREAK, SWITCH NEUTRAL ELECTRONIC CIRCUIT BREAKER

(71) Applicant: SCHNEIDER ELECTRIC USA, INC., Andover, MA (US)

(72) Inventor: Chad MITTELSTADT, I, Cedar Rapids, IA (US)

(73) Assignee: SCHNEIDER ELECTRIC USA, INC., Andover, MA (US)

(21) Appl. No.: 16/227,025

(22) Filed: Dec. 20, 2018

(51) Int. Cl. H01H 71/12; H01H 71/02; H01H 71/04

(52) U.S. Cl. CPC H01H 71/12; H01H 71/04; H01H 71/0207

(57) ABSTRACT

A circuit breaker has a first stationary contact connected to line power and a second stationary contact connected to neutral. A first moveable contact coupled to a load power terminal, is mounted on a moveable actuator and juxtaposed with the first stationary contact to form a power circuit when the first moveable and first stationary contacts are closed. A second moveable contact connected to a load neutral terminal is mounted on the moveable actuator juxtaposed with the second stationary contact to form a neutral circuit when the second moveable and second stationary contacts are closed. The movable actuator moves the first and second moveable contacts in unison to open the power circuit between the first stationary and first moveable contacts and to simultaneously open the neutral circuit between the second stationary and second moveable contacts, in response to actuation of an operating handle or to sensing a tripping event.

### FIELD OF THE INVENTION

The invention disclosed relates to circuit breakers.

### BACKGROUND

Miniature circuit breakers are well known in the prior art. An illustrative circuit breaker design is disclosed in U.S. Pat. No. 5,245,302, which is assigned to the same assignee as the present application, and the disclosure in which is incorporated herein by reference. As illustrated in the '302 patent, the basic miniature automatic circuit breaker comprises a base and cover, a line power terminal, a load power terminal, and an electrical circuit between the line terminal and a load terminal. The electrical circuit includes a stationary contact and a movable contact secured to a contact carrier, which is movable between a contact OPEN position and a contact CLOSED position to open or close the electrical circuit. The circuit breaker includes an arc interrupting chamber, an operating mechanism for opening and closing the contacts, and a current responsive trip mechanism, which releases the operating mechanism to open the contacts in response to a sustained moderate overload or an instantaneous short circuit.

Modern miniature circuit breakers incorporate light emitting diodes (LEDs) to enable users to easily identify the trip condition and type of fault, for example an arc fault or ground fault. In some embodiments, the circuit for the LEDs is powered from the line power side, to ensure that the LEDs remain lit when the circuit breaker is tripped. However, an electrical shock hazard may occur if the neutral terminal of the circuit breaker is inadvertently disconnected, causing power from the line power side to flow through the circuit for the LEDs and be present on the load neutral terminal of the circuit breaker.

### SUMMARY

By contrast, the invention provides a simple, safe, practical and easily manufactured miniature circuit breaker, which provides power from the line power side to the electronics board or printed circuit board assembly (PCBA), while preventing an electrical shock hazard if the neutral terminal of the circuit breaker is inadvertently disconnected. The PCBA may provide power to LEDS or power other functions, such as denial of service solenoids or internal communications hardware, such as radio transmitters and receivers. In accordance with the invention, the circuit breaker includes separate contact pairs for the line power terminal to load power terminal circuit path and for the neutral terminal to load neutral terminal circuit path, and both contact pairs are simultaneously opened and closed in unison. The PCBA is directly connected across the line power terminal and the neutral terminal and remains connected when both pairs of contacts are opened. However, when both pairs of contacts are opened, both line power and neutral circuit paths are interrupted from connection to the load power and load neutral terminals, to prevent power from the line power side to flow through the circuit for the PCBA and be present on the load neutral terminal of the circuit breaker.

### DESCRIPTION OF THE FIGURES

FIGS. 1A and 1B are circuit diagrams of a prior art circuit breaker, showing a miniature circuit breaker that incorporates an electronics board powered from the load side, but power to the LEDs is interrupted when the breaker contacts are opened.

FIGS. 2A and 2B are circuit diagrams of a prior art circuit breaker, showing a miniature circuit breaker that incorporates an electronics board powered from the line power side, but an electrical shock hazard may occur if the neutral terminal of the circuit breaker is inadvertently disconnected, causing power from the line power side to flow through the circuit for the electronics board and be present on the load neutral terminal of the circuit breaker.

FIGS. 3A and 3B are circuit diagrams of a circuit breaker in accordance with the invention, showing a miniature circuit breaker that incorporates an electronics board powered from the line power side. Power is provided from the line power side to the electronics board, while preventing an electrical shock hazard if the neutral terminal of the circuit breaker is inadvertently disconnected. The circuit breaker includes separate contact pairs for the line power terminal to load power terminal circuit path and for the neutral terminal to load neutral terminal circuit path, and both contact pairs are simultaneously opened and closed in unison. When both pairs of contacts are opened, both line power and neutral circuit paths are interrupted from connection to the load power and load neutral terminals, to prevent power from the line power side to flow through the circuit for the electronics board and be present on the load neutral terminal of the circuit breaker.

FIG. 4A is a front perspective view from the top left side of the circuit breaker of FIGS. 3A and 3B, in the contact pairs CLOSED or in the ON position, in accordance with the invention. The circuit breaker includes separate contact pairs for the line power terminal to load power terminal circuit path and for the neutral terminal to load neutral terminal circuit path, and both contact pairs are simultaneously opened and closed in unison. The circuit for the electronics board is directly connected across the line power terminal and the neutral terminal and remains connected when both pairs of contacts are opened. However, when both pairs of contacts are opened, both line power and neutral circuit paths are interrupted from connection to the load power and load neutral terminals, to prevent power from the line power side to flow through the circuit for the electronics board and be present on the load neutral terminal of the circuit breaker, in accordance with the invention.

FIG. 4B is a front perspective view from the top left side of the circuit breaker of FIGS. 3A and 3B, in the contact pairs OPEN or in the OFF position, in accordance with the invention.

FIG. 4C is a front view of the circuit breaker of FIGS. 3A and 3B, in the contact pairs OPEN or in the OFF position, in accordance with the invention.

### DESCRIPTION OF EMBODIMENTS OF THE INVENTION

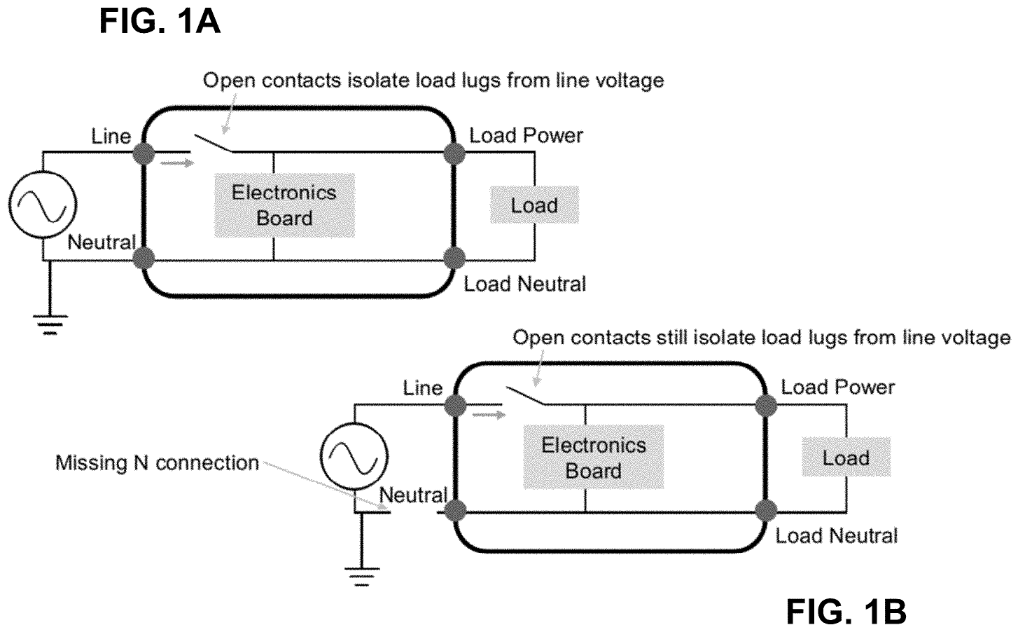

FIGS. 1A and 1B are circuit diagrams of a prior art circuit breaker that incorporates an electronics board that includes light emitting diodes (LEDs) to enable users to easily identify the trip condition and type of fault, for example an arc fault or ground fault. The circuit for the electronics board is powered from the load side, but power to the electronics board is interrupted when the breaker contacts are opened.

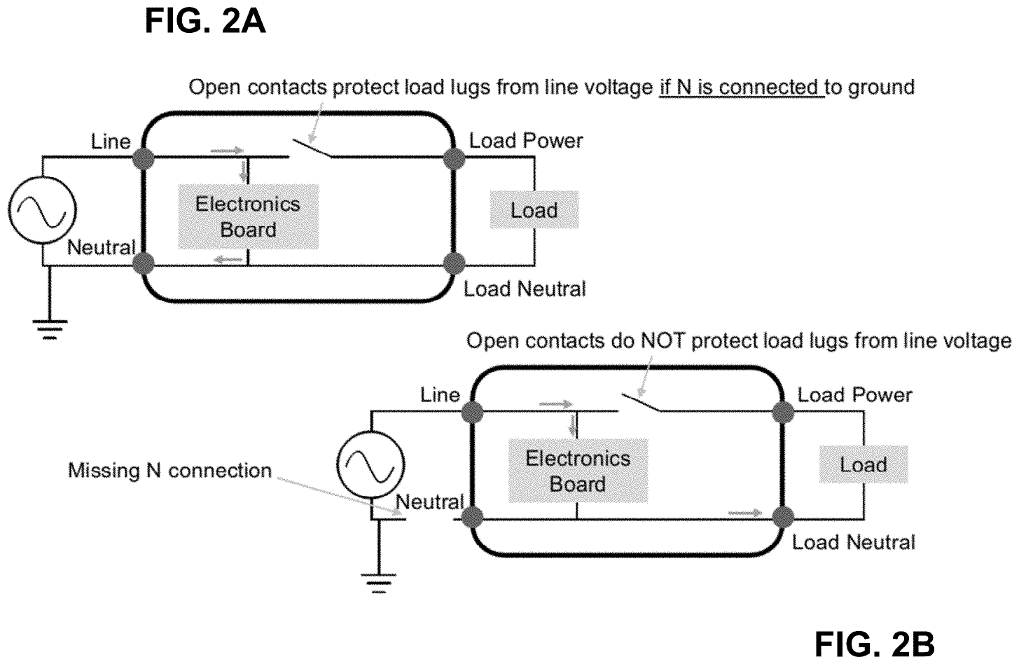

FIGS. 2A and 2B are circuit diagrams of a prior art circuit breaker, showing a miniature circuit breaker that incorporates an electronics board that includes light emitting diodes (LEDs) powered from the line power side to ensure that the LEDs remain lit when the circuit breaker is tripped. However, an electrical shock hazard may occur if the neutral terminal of the circuit breaker is inadvertently disconnected, causing power from the line power side to flow through the circuit for the electronics board and be present on the load neutral terminal of the circuit breaker.

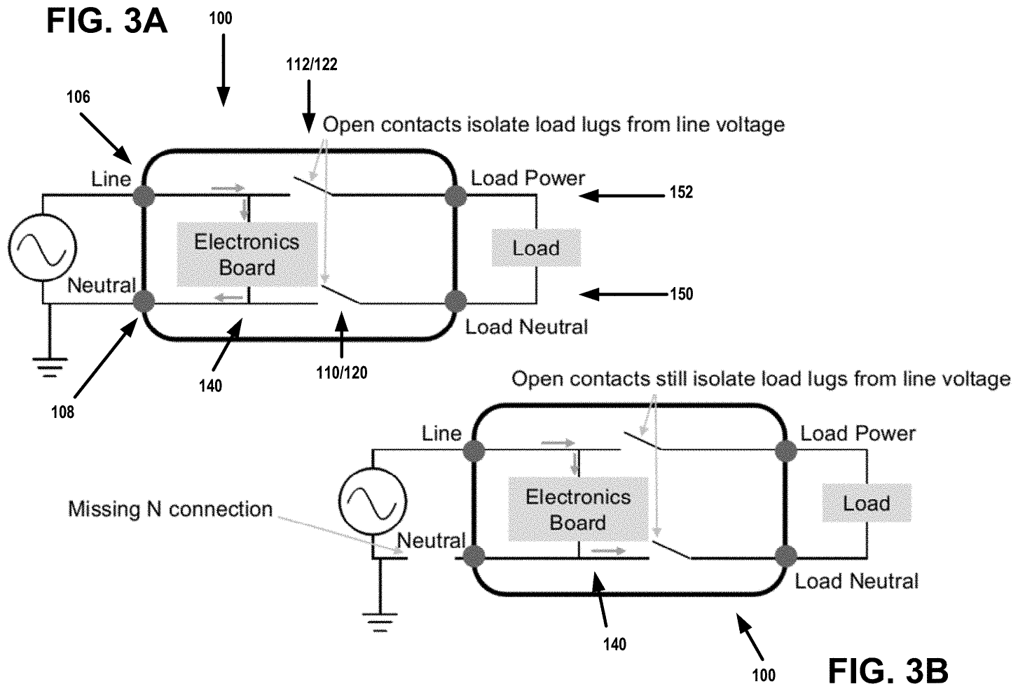

FIGS. 3A and 3B are circuit diagrams of a circuit breaker 100 in accordance with the invention, showing a miniature circuit breaker that incorporates an electronics board or printed circuit board assembly (PCBA) 140 powered from the line power side 106. The PCBA 140 may provide power to LEDS or power other functions, such as denial of service solenoids or internal communications hardware, such as radio transmitters and receivers. Power is provided from the line power side to the PCBA, while preventing an electrical shock hazard if the neutral terminal 108 of the circuit breaker is inadvertently disconnected. The circuit breaker includes separate contact pairs 112/122 for the line power terminal 106 to load power terminal 152 circuit path and contact pairs 110/120 for the neutral terminal 108 to load neutral terminal 150 circuit path, and both contact pairs are simultaneously opened and closed in unison. When both pairs of contacts 110/120 and 112/122 are opened, both line power circuit path 106/152 and neutral circuit path 108/150 are interrupted from connection to the load power 152 and load neutral 150 terminals, to prevent power from the line power side 106 to flow through the circuit board 140 and be present on the load neutral terminal 150 of the circuit breaker.

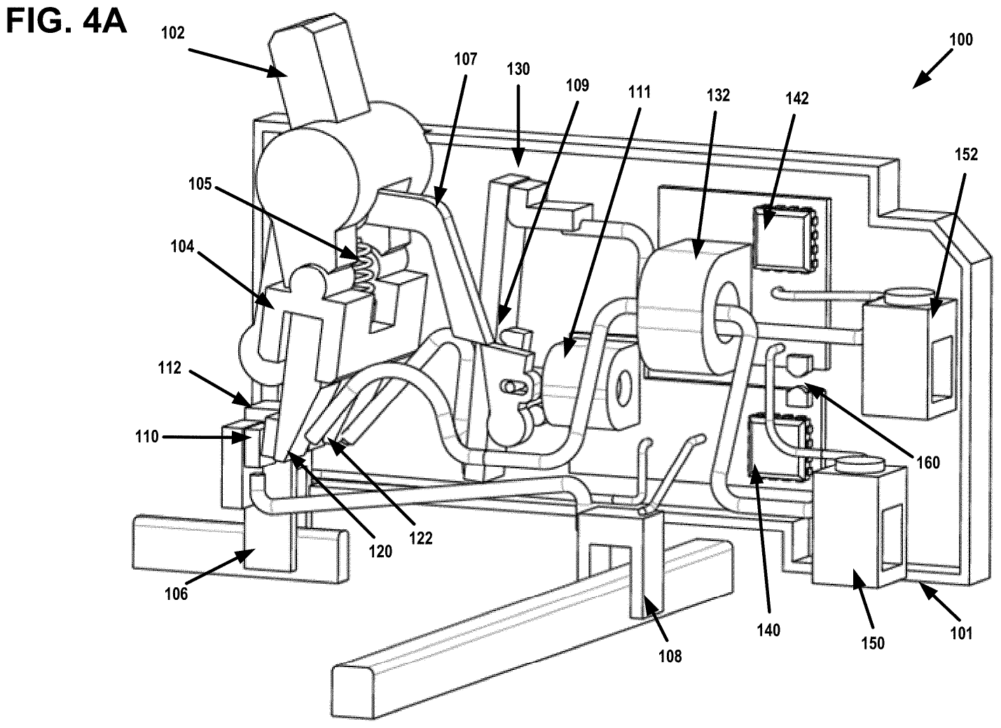

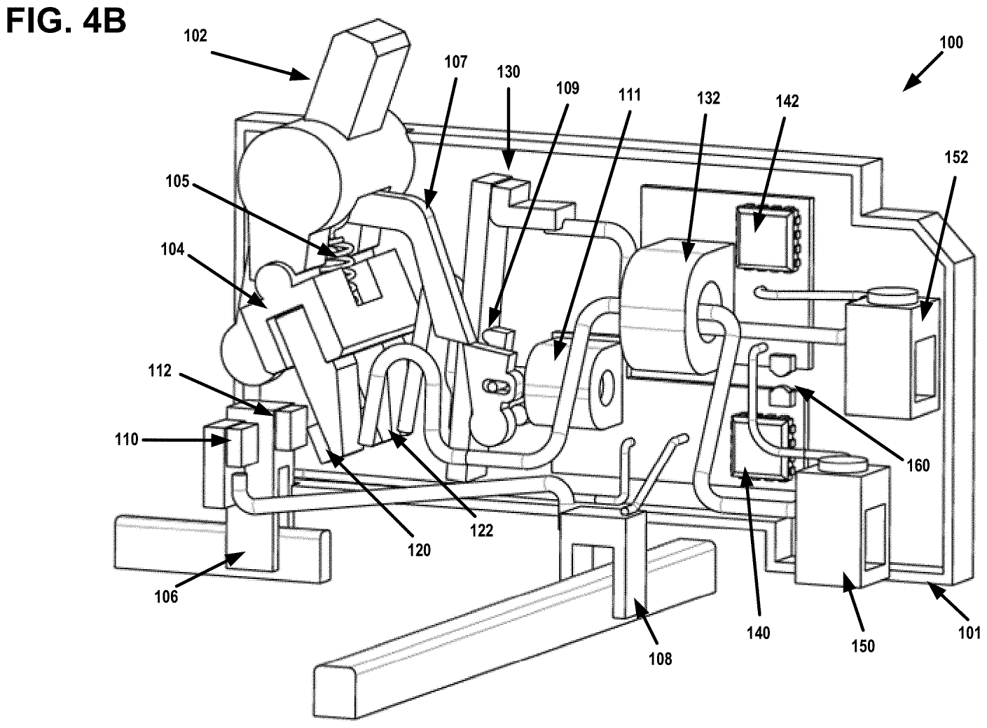

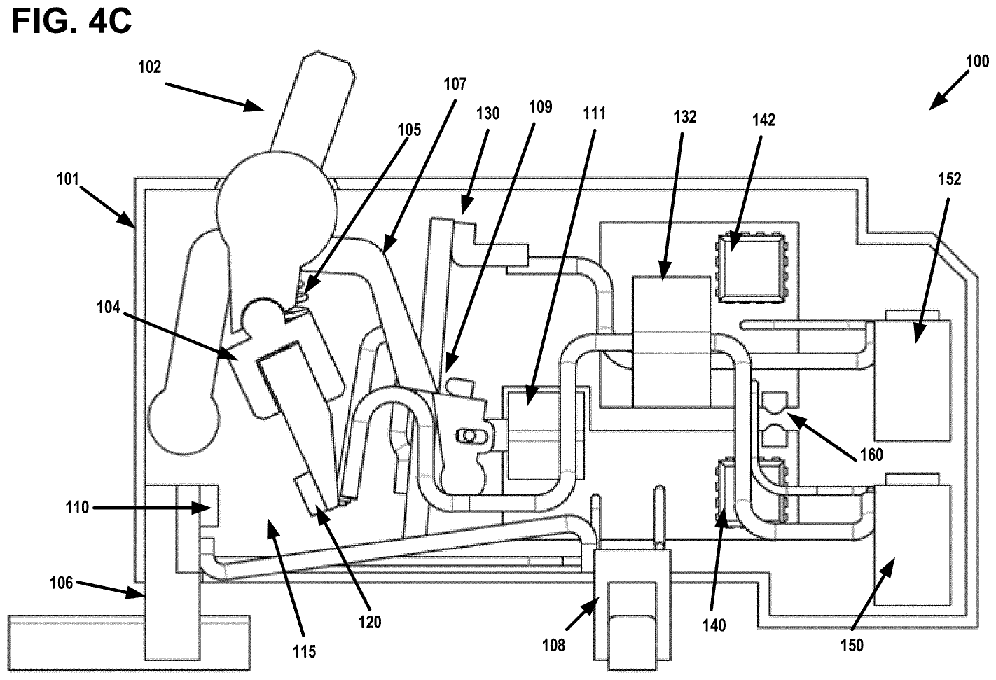

FIG. 4A is a front perspective view from the top left side of the circuit breaker of FIGS. 3A and 3B, with the contact pairs 110/120 and 112/122 CLOSED or in the ON position, in accordance with the invention. The circuit breaker 100 includes a housing 101 of the circuit breaker, including an operating handle 102 and an overcurrent tripping mechanism 130.

The circuit breaker 100 includes a first stationary contact 112 in the housing, connected to a line power terminal 106 of the circuit breaker.

The circuit breaker 100 includes a second stationary contact 110 in the housing, connected to a neutral terminal 108 of the circuit breaker.

The circuit breaker 100 includes a first moveable contact 122 in the housing, coupled to a load power terminal 152 of the circuit breaker, the first moveable contact 122 mounted on a moveable actuator 104 and juxtaposed with the first stationary contact 112 to form a power circuit between the line power terminal 106 and the load power terminal 152 when the first moveable 122 and first stationary contacts 112 are closed.

The circuit breaker 100 includes a second moveable contact 120 in the housing, connected to a load neutral terminal 150 of the circuit breaker, the second moveable contact 120 mounted on the moveable actuator 104 juxtaposed with the second stationary contact 110 to form a neutral circuit between the neutral terminal 108 and the load neutral terminal 150 when the second moveable 120 and second stationary 110 contacts are closed.

The movable actuator 104 is configured to move the first 122 and second 120 moveable contacts in unison to open the power circuit between the respective first stationary 112 and first moveable contacts 122 and simultaneously to open the neutral circuit between the second stationary 110 and second moveable 120 contacts, in response to an actuation of the operating handle 102 or to the overcurrent tripping mechanism 130 sensing a tripping event, as shown in FIG. 4B. The overcurrent tripping mechanism 130 includes a firing or trip solenoid 111 that releases a trip latch 109 that moves a trip lever 107 that toggles the moveable actuator 104 to open both pairs of contacts 110/120 and 112/122 when an overcurrent condition is detected. The movable actuator 104 toggles between the CLOSED position in FIG. 4A and the OPEN position in FIG. 4B with the toggle spring 105. The movable actuator 104 also provides an electrical isolation barrier between the first and second moveable contacts 120 and 122.

The circuit breaker 100 includes a load-powered circuit board 142 that writes the fault type of the tripping event, via the opto-coupler 160, to the line-powered circuit board 140, at the same time as the firing or trip solenoid 111 releases the trip latch 109 that moves the trip lever 107 to open both pairs of contacts 110/120 and 112/122. The LEDs in the line-powered circuit board 140 then display the type of fault. The circuit board 140 may also host communication hardware, such as radio transmitters and receivers to communicate the tripped state of the contacts. The circuit board 140 may also host denial of service hardware, such as circuits and solenoids to move the moveable actuator 104, to turn the circuit breaker on and off, for example in response to commands received by the radio receiver.

The circuit breaker 100 includes a reduced size arc chamber 115 (shown in FIG. 4C) in the housing 101 surrounding the first and second stationary contacts 110/112 and the first and second moveable contacts 120/122, corresponding to a reduced size air gap between the first moveable contact and first stationary contact and a reduced size air gap between the second moveable contact and the second stationary contact. The reduced size air gaps are based on dividing in half, an arc current flowing between the first and second stationary contacts and the first and second moveable contacts.

FIG. 4B is a front perspective view from the top left side of the circuit breaker of FIGS. 3A and 3B, with the contact pairs 110/120 and 112/122 OPEN or in the OFF position, in accordance with the invention. The operating handle 102 is shown in an OFF position and the contact pairs opened. The movable actuator 104 is configured to move the first 122 and second 120 moveable contacts in unison to open the power circuit between the respective first stationary 112 and first moveable contacts 122 and simultaneously to open the neutral circuit between the second stationary 110 and second moveable 120 contacts, in response to an actuation of the operating handle 102 or to the overcurrent tripping mechanism 130 sensing a tripping event.

FIG. 4C is a front view of the circuit breaker of FIGS. 3A and 3B and FIG. 4B, with the contact pairs OPEN or in the OFF position, in accordance with the invention. The view in FIG. 4C provides a clearer indication of the reduced size arc chamber 115 in the housing and a reduced size air gap between the moveable contact 120 and the stationary contact 110. The reduced size air gaps are based on dividing in half, an arc current flowing between the stationary contacts 110/112 and the moveable contacts 120/122.

Although specific example embodiments of the invention have been disclosed, persons of skill in the art will appreciate that changes may be made to the details described for the specific example embodiments, without departing from the spirit and the scope of the invention.

1. A circuit breaker, comprising:
a first stationary contact connected to a line power terminal of the circuit breaker;
a second stationary contact connected to a neutral terminal of the circuit breaker;
a first moveable contact coupled to a load power terminal of the circuit breaker, the first moveable contact mounted on a moveable actuator and juxtaposed with the first stationary contact to form a power circuit between the line power terminal and the load power terminal when the first moveable and first stationary contacts are closed;
a second moveable contact connected to a load neutral terminal of the circuit breaker, the second moveable contact mounted on the moveable actuator juxtaposed with the second stationary contact to form a neutral circuit between the neutral terminal and the load neutral terminal when the second moveable and second stationary contacts are closed; and
the movable actuator configured to move the first and second moveable contacts in unison to open the power circuit between the first stationary and first moveable contacts and simultaneously to open the neutral circuit between the second stationary and second moveable contacts.

2. The circuit breaker of claim 1, further comprising:
a housing of the circuit breaker, including an operating handle and an overcurrent tripping mechanism; and
the movable actuator configured to move the first and second moveable contacts in response to an actuation of the operating handle or to the overcurrent tripping mechanism sensing a tripping event.

3. The circuit breaker of claim 2, further comprising:
a reduced size arc chamber in the housing surrounding the first and second stationary contacts and the first and second moveable contacts, corresponding to a reduced size air gap between the first moveable contact and first stationary contact and a reduced size air gap between the second moveable contact and the second stationary contact, based dividing arc current flow between the first and second stationary contacts and the first and second moveable contacts.

4. The circuit breaker of claim 1, further comprising:
a line powered circuit board including at least one of light emitting diodes (LEDs), denial of service hardware, or communication hardware, directly connected across the line power terminal and the neutral terminal, which remains connected when the first and second stationary contacts and the first and second moveable contacts are opened;
whereby power is provided from the line power side to the circuit board, while preventing an electrical shock hazard if the neutral terminal of the circuit breaker is inadvertently disconnected.

5. The circuit breaker of claim 1, further comprising:
a load-powered circuit board configured to write a fault type of a tripping event, via an opto-coupler, to a line-powered circuit board, at the same time that the first and second stationary contacts and the first and second moveable contacts are opened; and
light emitting diodes (LEDs) directly connected across the line power terminal and the neutral terminal, configured to display the type of fault.
